(19) United States
(12) Patent Application Publication
(10) Pub. No.: US 2010/0245611 A1
(43) Pub. Date: Sep. 30, 2010

(54) CAMERA SYSTEM AND IMAGE ADJUSTING METHOD FOR THE SAME

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/432,712

(22) Filed: Apr. 29, 2009

(30) Foreign Application Priority Data
Mar. 25, 2009 (CN) 200910301127.6

(51) Int. Cl. H04N 5/228

(52) U.S. Cl. 348/222.1

(57) ABSTRACT

A camera system is capable of adjusting a location of a target in an image including the target. The camera system captures the image including the target, obtains the target from the image, and calculates a coordinate difference between the target and a determined location of the image. The camera system also transmits a drive command for a driving module according to the coordinate difference, and the driving module adjusts the image according to the drive command to adjust the location of the target relative to the determined location in the image.

### BACKGROUND

1. Technical Field

The present disclosure relates to camera systems, and particularly to a camera system and an image adjusting method for the camera system.

2. Description of Related Art

Generally, a camera employed to automatically track a target cannot automatically capture a clear image of the target. For example, a camera in a traffic management system is capable of detecting a license plate via vehicle license plate recognition (VLPR) system. However, the camera cannot automatically aim itself to locate the license plate at a determined location of the image. Therefore, the image of the license plate is not clear sometimes.

### BRIEF DESCRIPTION OF THE DRAWINGS

FIG. 1 is a block diagram of an exemplary embodiment of a camera system.

FIG. 2A is a sketch map showing an image captured by the camera system of FIG. 1.

FIG. 2B is a sketch map of the image in FIG. 2A adjusted by the camera system.

FIG. 3 is a flowchart of an exemplary embodiment of an image adjusting method for the camera system of FIG. 1.

### DETAILED DESCRIPTION

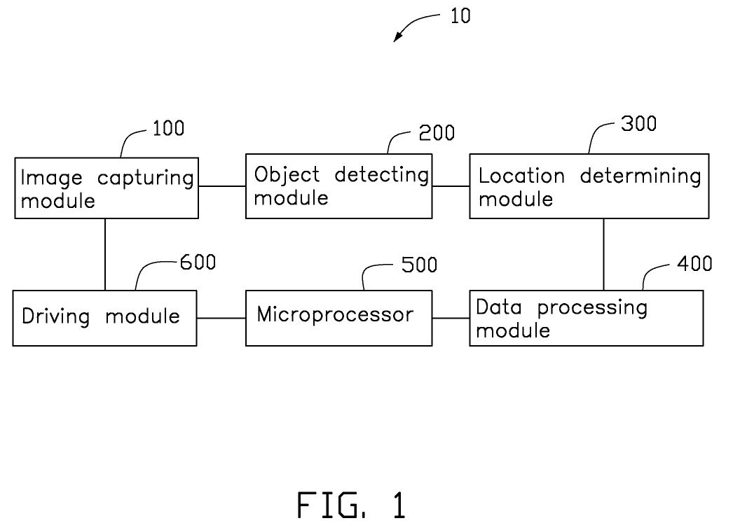

Referring to FIG. 1, an exemplary embodiment of a camera system 10 includes an image capturing module 100, an object detecting module 200, a location determining module 300, a data processing module 400, a microprocessor 500, and a driving module 600.

The image capturing module 100 captures an image including a target. In one exemplary embodiment, the image capturing module 100 may include a charge coupled device (CCD) and a lens. The target may be a license plate, a human face, and so on.

The object detecting module 200 calculates the image captured by the image capturing module 100 to obtain the target. The object detecting module 200 may be a well-known object recognition system, such as a vehicle license plate recognition (VLPR) system, a face recognition system, and so on. The object detecting module 200 may calculate characteristic values of the image to obtain the target. For example, when the target is a license plate, the object detecting module 200 calculates the characteristic values of the image to obtain the license plate. The characteristic values may be pix values.

The location determining module 300 calculates a location of the target obtained by the object detecting module 200. The location of the target is a coordinate value in the image.

The data processing module 400 calculates a coordinate difference between the location of the target and a determined location in the image, and calculates a resolution of the target in the image via calculating pix values of the image. In one exemplary embodiment, the determined location is a center of the image.

The microprocessor 500 receives the coordinate difference and the resolution of the target from the data processing module 400, and transmits a drive command including a first drive command relative to the coordinate difference and a second drive command relative to the resolution of the target, to the driving module 600.

The drive module 600 adjusts a lens angle and a focus of the image capturing module 100 according to the drive command from the microprocessor 500, thereby to aim the image capturing module so that the target is located at the center of the image and has a higher resolution. The driving module 600 may include a motor and a driver. The driver drives the motor according to the drive command from the microprocessor 500 to adjust the lens angle and the focus of the image capturing module 100.

In one exemplary embodiment, the location determining module 300 and the data processing module 400 can be selectively integrated into the microprocessor 500. The aim of the image capturing module can be adjusted so that the target is located at other locations of the image instead of the center, for example, a top left corner or a top right corner of the image. An example of using a license plate as the target is given below to explain the camera system 10 in detail.

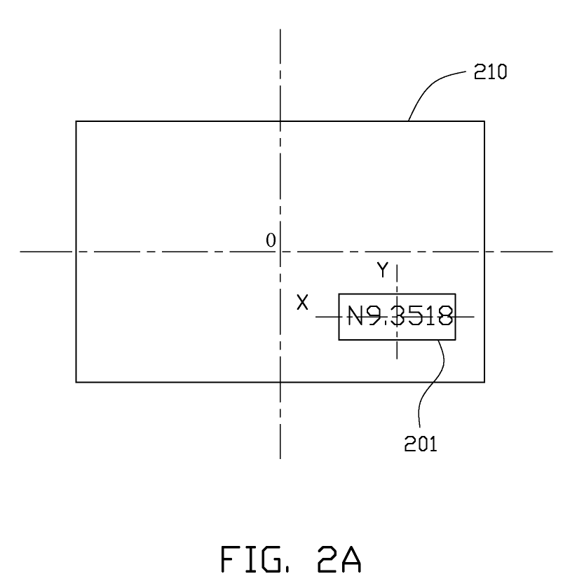

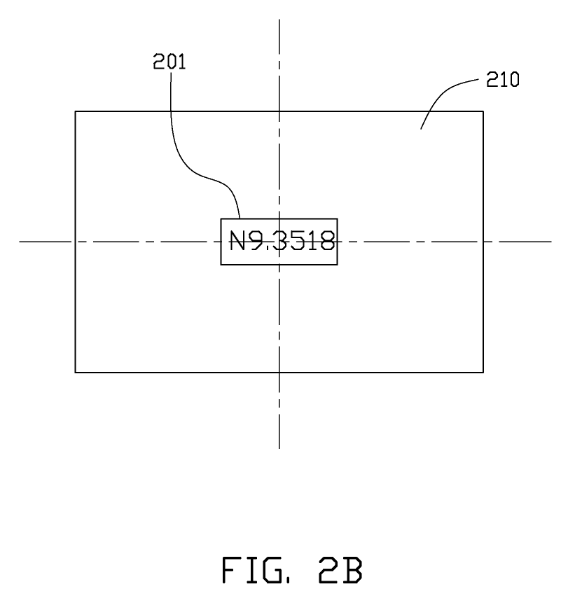

Referring to FIG. 2A and FIG. 2B, in use, the image capturing module 100 captures an image 210 which includes a license plate 201. The object detecting module 200 obtains a fix on the license plate 201 via calculating characteristic values of the license plate 201. The location determining module 300 calculates a location of the license plate 201 in the image 210, which is a coordinate value (X, Y). The data processing module 400 calculates a coordinate difference between the location of the license plate 201 and the center O of the image 210. For example, when the center O of the image 210 is defined as an origin of the coordinate, the coordinate difference between the location of the license plate 201 and the center O of the image 210 is about (−X, −Y). At the same time, the data processing module 400 also calculates pixel values of the license plate 201 to obtain a resolution of the license plate 201. The microprocessor 500 transmits a drive command including a first drive command relative to the coordinate difference and a second drive command relative to the resolution of the license plate 201, to the driving module 600 to adjust the lens angle and the focus of the image capturing module 100, so the license plate 201 will be located at the center O of the image 210 and have a higher resolution.

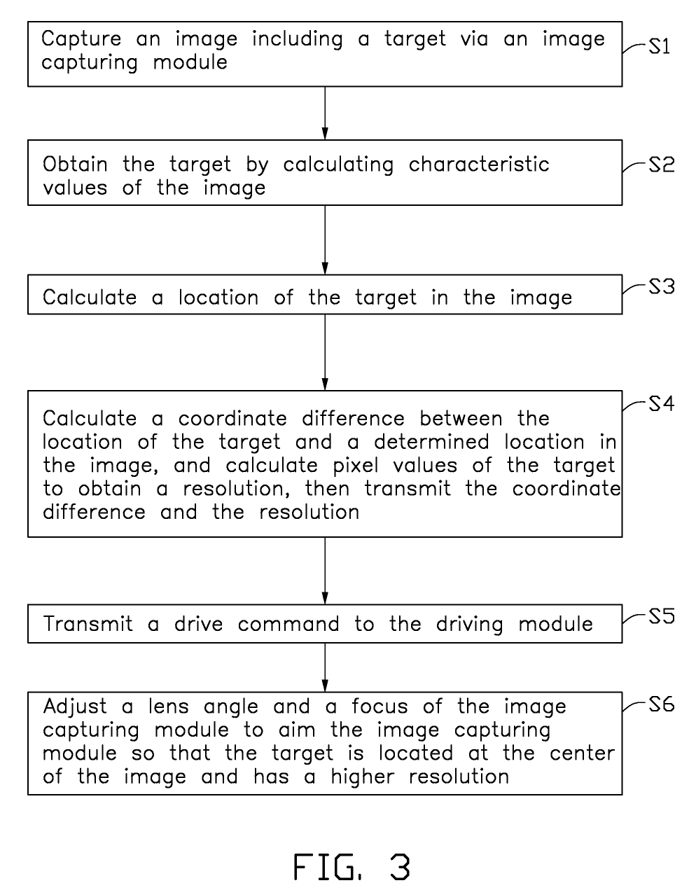

Referring to FIG. 3, an image adjusting method for the camera system 10 is provided, which includes the following steps.

In step S1, the image capturing module 100 captures an image including a target.

In step S2, the object detecting module 200 obtains the target by calculating characteristic values of the image.

In step S3, the location determination module 300 calculates a location of the target in the image.

In step S4, the data processing module 400 calculates a coordinate difference between the location of the target and a determined location in the image, and also calculates pixel values of the target to obtain a resolution of the target, then transmits the coordinate difference and the resolution to the microprocessor 500.

In step S5, the microprocessor 500 transmits a drive command including a first drive command relative to the coordinate difference and a second drive command relative to the resolution of the target, to the driving module 600.

In step S6, the driving module 600 adjusts a lens angle and a focus of the image capturing module 100, thereby to aim the image capturing module so that the target is located at the center of the image and has a higher resolution.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A camera system, comprising:
an image capturing module to capture an image comprising a target;
an object detecting module to obtain the target in the image;
a location determining module to calculate a location of the target in the image;
a data processing module to calculate a coordinate difference between the location of the target and a determined location in the image;
a microprocessor to receive the coordinate difference and transmit a first drive command according to the coordinate difference; and
a driving module to adjust a lens angle of the image capturing module according to the first drive command from the microprocessor, thereby to adjust the location of the target relative to the determined location in the image.

2. The system of claim 1, wherein the object detecting module obtains the target in the image by calculating characteristic values of the image.

3. The system of claim 1, wherein the characteristic values of the image is pixel values of the image.

4. The system of claim 1, wherein the determined location in the image is a center of the image.

5. The system of claim 1, wherein the data processing module is further to calculate a resolution of the target in the image.

6. The system of claim 5, wherein the microprocessor is further transmit a second drive command to the driving module according to the resolution of the target.

7. The system of claim 6, wherein the drive module is further to adjust a focus of the image capturing module according to the second drive command.

8. A camera system, comprising:
an image capturing module to capture an image comprising a target;
an object detecting module to obtain the target in the image;
a microprocessor to calculate a coordinate difference between a location of the target and a determined location in the image, and transmit a first drive command according to the coordinate difference; and
a driving module to adjust a lens angle of the image capturing module according to the first drive command from the microprocessor, thereby to adjust the location of the target relative to the determined location in the image.

9. The system of claim 8, wherein the object detecting module obtains the target in the image by calculating characteristic values of the image.

10. The system of claim 8, wherein the characteristic values of the image is pixel values of the image.

11. The system of claim 8, wherein the determined location in the image is a center of the image.

12. The system of claim 8, wherein the microprocessor is further to calculate a resolution of the target in the image.

13. The system of claim 12, wherein the microprocessor is further to transmit a second drive command to the driving module according to the resolution of the target.

14. The system of claim 13, wherein the drive module is further to adjust a focus of the image capturing module according to the second drive command.

15. An image adjusting method for a camera system comprising an image capturing module, the method comprising:
capturing an image comprising a target via the image capturing module;
obtaining the target in the image;
calculating a location of the target in the image;
calculating a coordinate difference between the location of the target and a determined location in the image;
transmitting a first drive command to a drive module according to the coordinate difference; and
adjusting a lens angle of the image capturing module according to the first drive command by the drive module to adjust the location of the target relative to the determined location in the image.

16. The method of claim 15, wherein the target is obtained by calculating characteristic values of the image.

17. The method of claim 15, wherein the characteristic values of the image is pixel values of the image.

18. The method of claim 15, wherein the determined location is a center of the image.

19. The method of claim 15, further comprising:
calculating a resolution of the target in the image;
transmitting a second drive command to the driving module according to the resolution; and
adjusting a focus of the image capturing module according to the second drive command.

20. The method of claim 19, wherein the resolution of the target is obtained by calculating pixel values of the image.
